(19) United States
(12) Patent Application Publication
(10) Pub. No.: US 2026/0178244 A1
(43) Pub. Date: Jun. 25, 2026

(54) IMAGE FORMATION MONITORING METHOD, IMAGE FORMATION MONITORING APPARATUS, IMAGE FORMATION MONITORING SYSTEM, AND STORAGE MEDIUM

(71) Applicant: Konica Minolta, Inc., Tokyo (JP)

(72) Inventor: Takashi AJIOKA, Tokyo (JP)

(21) Appl. No.: 19/424,458

(22) Filed: Dec. 18, 2025

(30) Foreign Application Priority Data
Dec. 25, 2024 (JP) 2024-228450

(51) Int. Cl. G06F 3/12

(52) U.S. Cl. CPC G06F 3/121; G06F 3/1204; G06F 3/1217; G06F 3/1235; G06F 3/1254

(57) ABSTRACT

An image formation monitoring method is performed by an image formation monitoring apparatus that manages replenishment information on a consumable stored in a container of an image forming apparatus. The image formation monitoring method includes: acquiring the replenishment information on a replenishment amount of the consumable replenished into the container; and causing a display to display the replenishment information in chronological order.

### CROSS-REFERENCE TO RELATED APPLICATIONS

The entire disclosure of Japanese Patent Application No. 2024-228450 filed on Dec. 25, 2024, is incorporated herein by reference in its entirety.

### BACKGROUND OF THE INVENTION

### Technical Field

The present disclosure relates to an image formation monitoring method, an image formation monitoring apparatus, an image formation monitoring system, and a storage medium.

### Description of Related Art

Conventionally, there is known an image forming apparatus that conveys a recording medium stored in a sheet feed section to an image forming section to form an image. In such an image forming apparatus, various problems occur depending on the condition of the recording medium. For example, when the humidity of the sheet feed section is high and the humidity of the recording medium increases, a conveyance error or an image quality error tends to occur. In addition, when the humidity of the sheet feed section is low and the humidity of the recording medium decreases, the recording medium becomes more susceptible to static electricity, making a conveyance error more likely to occur. When these errors occur, downtime increases and the productivity of image formation decreases, which is not preferable.

Various errors related to consumables in the image forming apparatus are dependent on environmental factors. Therefore, for errors such as those mentioned above, frequent replenishment of the recording medium can suppress their occurrence. On the other hand, in an effort to suppress error occurrence, users sometimes replenish media more frequently than necessary, ultimately increasing downtime and reducing image formation productivity.

Therefore, for example, JP 2010-235242A describes an image forming apparatus that includes a sensing section for detecting the height of sheets stored in a container and displays the number of replenishable sheet packs based on a reference storage height and the thickness of a sheet pack. According to this configuration, for example, by performing replenishment when the number of replenishable sheet packs reaches a predetermined amount, both the occurrence of environment-dependent errors and the increase in downtime due to the increased number of times of replenishment can be suppressed.

### SUMMARY OF THE INVENTION

However, as described above, JP 2010-235242A is an invention for an apparatus that only indicates the replenishable quantity. Therefore, it is not possible to detect problems with the replenishment content—such as low replenishment amounts requiring frequent refills—and prompt the user to make improvements.

Furthermore, the above problem is not limited to sheet replenishment but is a common problem for all consumables in an image forming apparatus, such as toner and ink.

The present disclosure has been made in view of such circumstances. An object of the present invention is to provide an image formation monitoring method, an image formation monitoring apparatus, an image formation monitoring system, and a storage medium capable of more appropriately performing replenishment of consumables in an image forming apparatus.

To achieve at least one of the abovementioned objects, an image formation monitoring method reflecting one aspect of the present invention is performed by an image formation monitoring apparatus that manages replenishment information on a consumable stored in a container of an image forming apparatus, the image formation monitoring method comprising: acquiring the replenishment information on a replenishment amount of the consumable replenished into the container; and causing a display to display the replenishment information in chronological order.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a block diagram illustrating an image formation monitoring system;

FIG. 2 is an example of a graph relating to remaining amounts of consumables, which is displayed on a display part;

FIG. 3 is an example of a graph relating to replenishment amounts of the consumables, which is displayed on the display part; and

FIG. 4 is an example of a flowchart of image formation monitoring processing.

### DETAILED DESCRIPTION

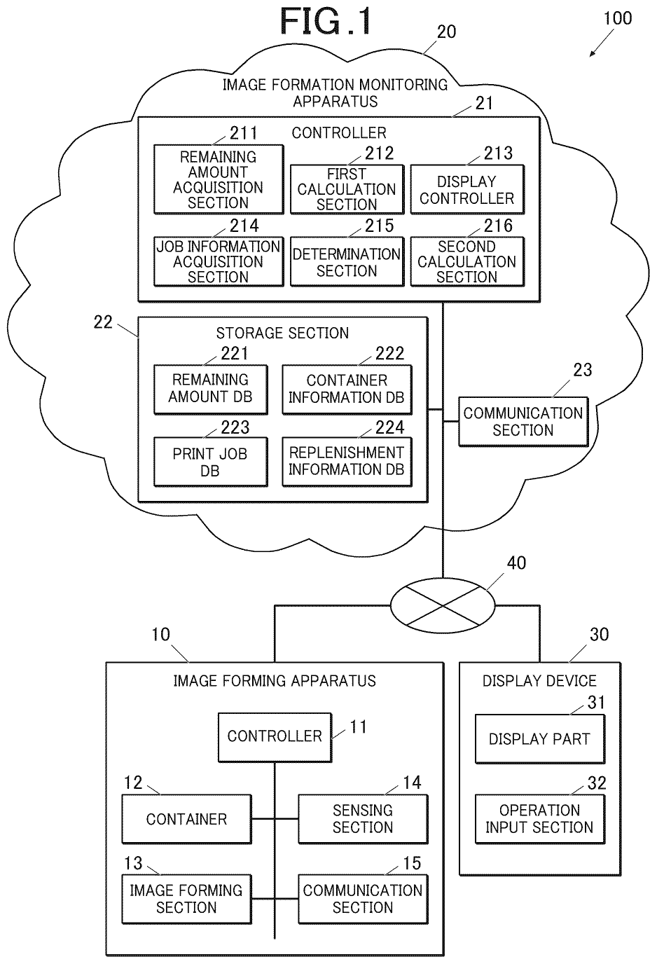

Hereinafter, modes (embodiments) for carrying out the present disclosure will be described with reference to FIGS. 1 to 4. However, the scope of the invention is not limited to the disclosed embodiments. In the present specification and the drawings, constituent elements having substantially the same functions or configurations are denoted by the same reference numerals, and redundant description thereof will be omitted.

### [Overall Configuration of Image Formation Monitoring System]

FIG. 1 illustrates a block diagram of an image formation monitoring system (hereinafter, “system”) 100 including an image formation monitoring apparatus (hereinafter, “monitoring apparatus”) 20 according to the present disclosure. As illustrated in FIG. 1, the system 100 according to the present disclosure includes an image forming apparatus 10, the monitoring apparatus 20, and a display device 30. The image forming apparatus 10, the monitoring apparatus 20, and the display device 30 can communicate with each other via a network 40. Note that although FIG. 1 illustrates one image forming apparatus 10 and one display device 30, the present invention is not limited thereto, and the system 100 may include a plurality of image forming apparatuses 10 and/or a plurality of display devices 30.

### (Image Forming Apparatus)

The image forming apparatus 10 is an apparatus capable of executing image formation processing for producing image-formed products such as catalogs or leaflets in which images are formed on various recording media. The image forming apparatus 10 includes a controller (hardware processor) 11, a container 12, an image forming section (image former) 13, a sensing section (sensor) 14, and a communication section 15.

### {Controller}

The controller 11 includes a central processing unit (CPU), a read-only memory (ROM), a random-access memory (RAM), and the like, and is a processor (computer) that integrally controls the operation of each unit in the image forming apparatus 10. The CPU reads a program such as an application (application program) stored in a storage section, develops the program in the RAM, and executes the program to perform various processes.

### {Container}

The container 12 stores various consumables that the image forming apparatus 10 consumes in the image formation processing.

### {Image Forming Section}

The image forming section 13 forms an image on a recording medium under the control of the controller 11.

The recording medium is in the form of a sheet, such as plain paper, thick paper, thin paper, Japanese paper, or special paper. Various recording media having different materials, basis weights, thicknesses, and sizes can be used.

In the following description, a case where the container 12 is a sheet feed section that stores a recording medium and the consumable is a recording medium will be described as an example. In such a case, the image forming apparatus 10 may include a plurality of containers 12, and different types of recording media may be stored in the plurality of containers 12.

Furthermore, in the following description, it is assumed that the image forming apparatus 10 is a laser printer that forms an image by an electrophotographic method. When the image forming apparatus 10 is a laser printer, the consumable may be toner and the container 12 may be a toner cartridge. The image forming apparatus 10 may be an inkjet recording apparatus that forms an image by an inkjet recording method, and in this case, the consumable may be ink and the container 12 may be an ink tank.

### (Sensing Section)

The sensing section 14 detects at least the remaining amount of the consumable stored in the container 12. The sensing section 14 includes, for example, a plurality of sensors. In the present embodiment, for example, the sensing section 14 is provided in each of the containers 12 and detects the remaining amount based on the height of the recording medium stored in the container 12 at predetermined time intervals. The sensing section 14 transmits the detected remaining amount of the consumable to the communication section 15.

Note that the information detected by the sensing section 14 in the container 12 is not limited to the remaining amount of the consumable. For example, a sensor for acquiring the temperature, humidity, and the like of the container 12 may be separately provided, and the detection information may be transmitted to the communication section 15. Furthermore, the detection method of the remaining amount of the consumable by the sensing section 14 is not limited to the detection of the height, but may be, for example, detection of the weight.

### {Communication Section}

The communication section 15 includes a communication interface or the like. The communication section 15 transmits and receives data to and from another device via the network 40 by using a predetermined communication protocol. The communication section 15 transmits the information acquired from the sensing section 14 to a remaining amount acquisition section 211, which will be described later, of the monitoring apparatus 20, associating the information with the sensing section 14 as a sending source.

Further, for example, when the communication section 15 receives a print job from an external device (not illustrated), the communication section 15 transmits the print job to the controller 11 to execute the image formation processing. In this step, the communication section 15 transfers the acquired print job to a job information acquisition section 214 (described later) of the monitoring apparatus 20. When an error occurs in the image forming apparatus 10, the communication section 15 transmits error information (a log or the like) acquired from the controller 11 to the job information acquisition section 214.

### (Image Formation Monitoring Apparatus)

The monitoring apparatus 20 monitors and manages image formation performed by the image forming apparatus 10 connected thereto via the network 40. The monitoring apparatus 20 is, for example, a cloud server realized by cloud computing, but is not limited thereto. The monitoring apparatus 20 may be a physical apparatus or may be operated on-premises. In addition, when the monitoring apparatus 20 is a physical apparatus, the monitoring apparatus 20 may include a plurality of devices. The monitoring apparatus 20 includes a controller (hardware processor) 21, a storage section 22, and a communication section 23.

### {Controller}

The controller 21 includes a CPU, a ROM, and a RAM, and is a processor (computer) that integrally controls the operation of each unit of the monitoring apparatus 20. The CPU reads programs such as application programs stored in the storage section 22, develops the programs in the RAM, and executes the programs to perform various processes. In particular, the controller 21 mainly functions as the remaining amount acquisition section 211, a first calculation section 212, a display controller 213, the job information acquisition section 214, a determination section 215, and a second calculation section 216 by the CPU executing the programs.

### <Remaining Amount Acquisition Section>

The remaining amount acquisition section 211 acquires the remaining amount of the consumable in a predetermined container 12 transmitted from the sensing section 14 via the communication sections 15 and 23 (remaining amount acquisition step). The remaining amount acquisition section 211 stores the acquired remaining amount of the consumable in a table for the predetermined container 12 in a remaining amount DB 221 to be described later.

### <First Calculation Section>

The first calculation section 212 calculates replenishment information based on a change in the remaining amount of the consumable in the predetermined container 12 acquired by the remaining amount acquisition section 211 (first calculation step).

For example, when the remaining amount acquisition section 211 acquires the remaining amount of the consumable in the predetermined container 12, the first calculation section 212 acquires data for the last remaining amount of the consumable in that container 12 from the remaining amount DB 221 and compares them. When the remaining amount of the consumable in the container 12 has increased, the first calculation section 212 determines that the container 12 has been replenished with the consumable. The first calculation section 212 then stores the replenishment information including the amount and timing of the increase in the remaining amount (i.e., replenishment amount and timing) in a replenishment information DB 224, which is described later.

In this way, the remaining amount acquisition section 211 and the first calculation section 212 cooperate with each other, and thus the controller 21 functions as a replenishment information acquisition section that acquires the replenishment information of the predetermined container 12 (replenishment information acquisition step). Note that the method by which the controller 21 acquires the replenishment information is not limited to the cooperation of the remaining amount acquisition section 211 and the first calculation section 212. For example, a configuration may be adopted in which replenishment information input by a user is acquired from a predetermined input device every time replenishment of the consumable is performed.

### <Display Controller>

Based on various programs and various data stored in the storage section 22, the display controller 213 transmits a predetermined display control signal to the display device 30 and causes a display part (display) 31, which will be described later, to perform desired display (display control step).

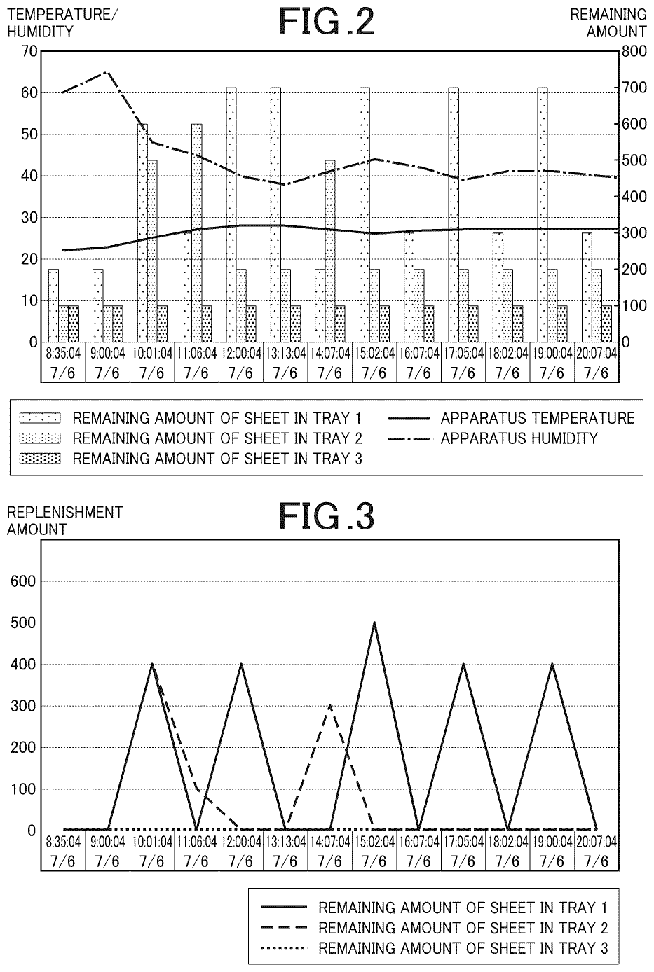

For example, upon receiving an instruction from the display device 30 to display the remaining amount and replenishment information of the consumable for the predetermined container 12, the display controller 213 acquires corresponding information from the remaining amount DB 221 and the replenishment information DB 224. Then, based on the acquired information, the display controller 213 causes the display part 31 to display a graph with the date and time on a first axis (X axis) and the remaining amount or the replenishment amount on a second axis (Y axis), as illustrated in FIGS. 2 and 3. In particular, as illustrated in FIG. 3, it is preferable to display a graph in which each of the replenishment timing and the replenishment amount is represented by an axis, since the frequency and the amount of replenishment can be visualized and the user can intuitively understand whether preferable replenishment is being performed.

Note that for the configuration in which the sensing section 14 also acquires information other than the remaining amount, for example, the temperature, the humidity, and the like of the container 12, the information stored in a container information DB 222, which will be described later, may be displayed together, as illustrated in FIG. 2.

In addition, in FIG. 3, a configuration in which the display controller 213 displays the replenishment amount of the consumable as the replenishment information is exemplified. However, for example, in a case where the storage capacities of the containers 12 differ even for the same type of consumable, it is difficult to understand the replenishment amounts even when the amounts are displayed numerically. Therefore, when the storage capacity of each container 12 is stored in the storage section 22 in advance, the display controller 213 may also display the replenishment ratio calculated by dividing the replenishment amount by the storage capacity.

Generally, in the image forming apparatus 10, a smaller number of times of replenishment of the consumable into the container 12 is preferable because downtime is shortened and productivity is improved. On the other hand, the user may attempt to replenish the container 12 with the consumable excessively frequently because of concern about the occurrence of an error due to storage of the consumable in the container 12. Therefore, based on the replenishment information, when the replenishment amount of the consumable into the container 12 is equal to or less than a predetermined value calculated by the second calculation section 216, the display controller 213 causes the display part 31 to display a warning. The predetermined value will be described later.

### <Job Information Acquisition Section>

The job information acquisition section 214 acquires the print job and the error information transmitted from the communication section 15 of the image forming apparatus 10 and stores them in a print job DB 223, which will be described later (job information acquisition step).

### <Determination Section>

The determination section 215 determines whether the replenishment content of the user is appropriate based on print job information and the replenishment information (determination step).

In the above description, the display controller 213 causes a warning to be displayed when the replenishment amount of the consumable into the container 12 is equal to or less than the predetermined value. However, even when the replenishment amount of the consumable into the container 12 is equal to or less than the predetermined value, if the print job is completed without performing replenishment again after the restart of the print job, the downtime will not increase further. In such a case, the occurrence of an error caused by the consumable remaining in the container 12 after the job is finished is also suppressed.

Therefore, when the replenishment amount of the consumable is equal to or less than the predetermined value in the replenishment information acquired by the controller 21, the determination section 215 acquires the print job information at that replenishment timing from the print job DB 223. Then, it is determined whether further replenishment of the consumable into the container 12 will become necessary between that replenishment and completion of the print job by the image forming apparatus 10. When the determination section 215 determines that replenishment of the consumable is unnecessary, the display controller 213 does not cause the display part 31 to display a warning.

### <Second Calculation Section>

The second calculation section 216 calculates preferable replenishment content based on the print job information and the storage capacity of the container 12. For example, the second calculation section 216 calculates the expected number of times of replenishment based on the print job information and the storage capacity of the container 12. The second calculation section 216 calculates the predetermined value of the replenishment amount based on the expected number of times of replenishment (second calculation step).

Specifically, it is assumed that a print job requires 5000 sheets of the recording medium to be stored in a predetermined container 12. Furthermore, it is assumed that the number of sheets of the recording medium that can be stored in the predetermined container 12 is 1500. As described above, since it is preferable that the number of times of replenishment is small, in this case, the second calculation section 216 calculates the expected number of times of replenishment to be four from 5000÷1500=3.3 . . . . Further, in order to complete the print job with four times of replenishment, the predetermined value of the replenishment amount is calculated as 1250 sheets from 5000/4=1250.

For example, suppose that the second calculation section 216 calculates that the expected number of times of replenishment is four. Then, based on the replenishment information, when the actual number of times of replenishment is five or more, the display controller 213 causes the display part 31 to display a warning. Moreover, suppose that the second calculation section 216 calculates that the predetermined value of the replenishment amount is 1250 sheets. Then, based on the replenishment information, when the actual replenishment amount is less than 1250 sheets, the display controller 213 causes the display part 31 to display a warning.

### {Storage Section}

The storage section 22 includes a hard disk drive (HDD) and a nonvolatile semiconductor memory. The storage section 22 stores various programs to be executed by the controller 21, various data, and the like. At least some of the various programs may be stored in the ROM or the like of the controller 21.

The storage section 22 stores a web server program, application programs, and the like. The web server program communicates with a web browser or a program installed in the display device 30 using the HTTP protocol or the like, provides a website for using the system 100, and realizes a function as a web server. The application programs operate on the web server to implement various types of processes.

Further, various DBs are constructed in the storage section 22. The DBs included in the storage section 22 include, for example, the remaining amount DB 221, the container information DB 222, the print job DB 223, and the replenishment information DB 224.

### <Remaining Amount DB, Container Information DB>

The remaining amount DB 221 stores the remaining amount of the consumable of each container 12 at a predetermined timing, which is acquired by the remaining amount acquisition section 211. The container information DB 222 stores the storage capacity of each container 12 for the consumable and information other than the remaining amount of the consumable in the container 12 detected by the sensing section 14. Note that the remaining amount DB 221 and the container information DB 222 may be integrated.

### <Print Job DB, Replenishment Information DB>

The print job DB 223 stores a print job performed by the image forming apparatus 10, information on an error that has occurred, and the like. The replenishment information DB 224 stores replenishment information for each container 12.

### {Communication Section}

The communication section 23 includes a communication module and the like. The communication section 23 transmits and receives various signals and various data to and from the image forming apparatus 10, the display device 30, and other devices connected thereto via the network 40.

### (Display Device)

The display device 30 is, for example, a personal computer including the display part 31, which is a display, and an operation input section 32, which is a keyboard, a mouse, or the like. When the display device 30 receives an operation of the operation input section 32 by the user, the display device 30 displays various image formation monitoring results acquired from the display controller 213 of the monitoring apparatus 20 on the display part 31.

Note that the display device 30 may not be provided when the monitoring apparatus 20 is a physical apparatus and has a configuration equivalent to the display part 31 and the operation input section 32.

### [Image Formation Monitoring Processing]

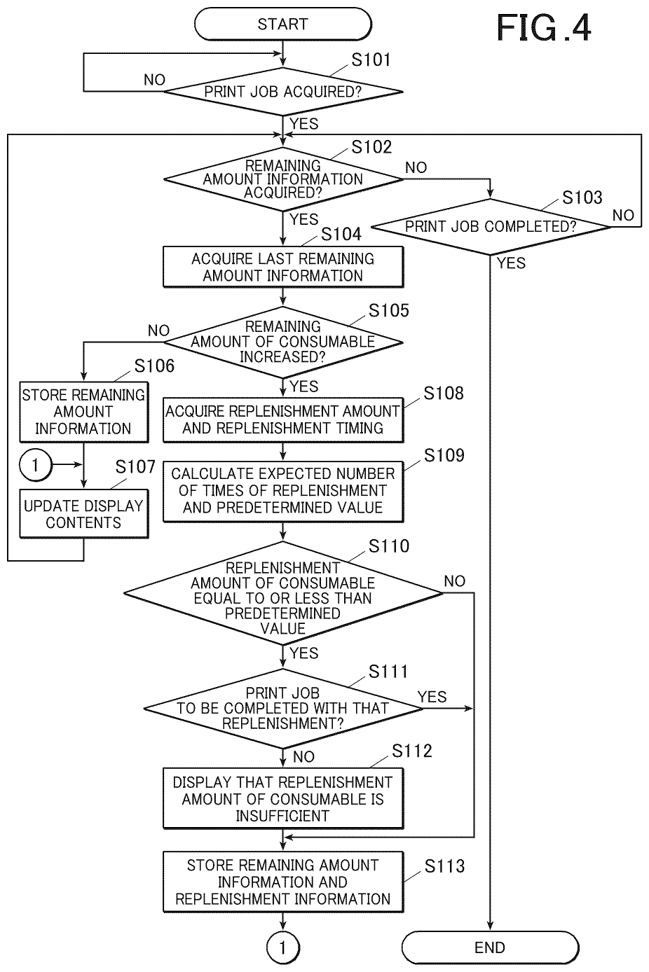

A flow of image formation monitoring processing in the above system 100 will be described with reference to the flowchart of FIG. 4.

First, the controller 21 determines whether the job information acquisition section 214 has acquired a print job from the image forming apparatus 10 (step S101). If the print job has not been acquired (step S101; No), the controller 21 advances the process to step S101 and stands by. If the print job has been acquired (step S101; Yes: job information acquisition step), the controller 21 starts the image formation monitoring processing.

In the image formation monitoring processing, the remaining amount acquisition section 211 periodically determines whether remaining amount information has been acquired from the sensing section 14 via the communication sections 15 and 23 (step S102). If the remaining amount information has not been acquired (step S102; No), the controller 21 determines whether the print job is completed (step S103). If the print job is not completed (step S103; No), the controller 21 advances the process to step S102 and stands by. If the print job is completed (step S103; Yes), the controller 21 ends the processing.

If the remaining amount acquisition section 211 acquires the remaining amount information (step S102; Yes: remaining amount acquisition step), the first calculation section 212 acquires, from the remaining amount DB 221, the last remaining amount information on the corresponding container 12 (step S104). Next, the first calculation section 212 compares the remaining amount information acquired in step S102 with the last remaining amount information acquired in step S104 to determine whether the remaining amount of the consumable in the corresponding container 12 has increased (step S105: first calculation step).

If the remaining amount of the consumable has not increased (step S105; No), replenishment has not been performed. Therefore, the remaining amount acquisition section 211 stores the remaining amount information acquired in step S102 in the remaining amount DB 221 (step S106). In addition, the display controller 213 updates the display contents of the remaining amount information and the replenishment information in chronological order displayed on the display part 31 (step S107: display control step). Then, the controller 21 advances the process to step S102.

On the other hand, if the remaining amount of the consumable has increased (step S105; Yes), the replenishment has been performed. Therefore, the controller 21 acquires the replenishment amount from the calculation result of step S105. Furthermore, the controller 21 acquires the replenishment timing from the acquisition time of the remaining amount information (step S108: replenishment information acquisition step).

The second calculation section 216 calculates the expected number of times of replenishment and the predetermined value based on the storage capacity of the container 12 stored in the container information DB 222 as described above and the print job information acquired in step S101 (step S109: second calculation step). Note that the execution timing of the second calculation step may be any time after step S101 and before step S110.

The determination section 215 determines whether the replenishment amount acquired in step S108 is equal to or less than the predetermined value calculated in step S109 (step S110). If the replenishment amount is equal to or less than the predetermined value (step S110; Yes), the determination section 215 determines whether the print job can be completed with that replenishment (step S111: determination step). If the print job cannot be completed (step S111; No), the display controller 213 causes the display part 31 to display a warning that the replenishment amount is insufficient (step S112). Further, the remaining amount acquisition section 211 and the first calculation section 212 store the remaining amount information and the replenishment information in the remaining amount DB 221 and the replenishment information DB 224, respectively (step S113). Then, the controller 21 advances the process to step S107, and the display controller 213 updates the display contents on the display part 31.

If the replenishment amount is larger than the predetermined value (step S110; No), or if the replenishment amount is equal to or less than the predetermined value but the print job can be completed with that replenishment (step S111; Yes), the display of the warning is unnecessary. Therefore, the controller 21 advances the process to step S113.

### Effects of Embodiment

As described above, the image formation monitoring method performed by the monitoring apparatus 20 according to the present embodiment includes a replenishment information acquisition step of acquiring information on the replenishment amount of a consumable replenished in the container 12. The image formation monitoring method further includes a display control step of causing the display part 31 to display the replenishment information in chronological order. According to the above-described configuration, when there is a problem in replenishment of consumables in the image forming apparatus 10, the problem can be visualized for improvement. Therefore, the replenishment of consumables can be executed more appropriately.

Furthermore, the replenishment information acquisition step in the image formation monitoring method according to the present embodiment includes a remaining amount acquisition step of acquiring the remaining amount of a consumable in the container 12 and a first calculation step of calculating the replenishment information based on the acquired remaining amount of the consumable. Then, the remaining amount acquisition step includes acquiring the remaining amount of the consumable in the container 12 based on the detection result of the sensing section 14 provided in the container 12. According to the above-described configuration, since the replenishment information can be automatically acquired based on the difference in the remaining amount of the consumable in the container 12 detected by the sensing section 14, it is possible to eliminate the need for the user to input the replenishment information.

Furthermore, the display control step in the image formation monitoring method according to the present embodiment includes causing the display part 31 to display, as the replenishment information, the ratio of the replenishment amount of the consumable to the storage capacity of the container 12. According to the above-described configuration, even when there is a variation in the storage capacity of the container 12, the user can more intuitively recognize whether the replenishment amount is large or small.

Further, the display control step in the image formation monitoring method according to the present embodiment includes causing the display part 31 to display, as the replenishment information, a graph indicating the replenishment amount into the container 12 in chronological order. According to the above-described configuration, the user can more intuitively recognize whether the user performs replenishment in such a way that the replenishment frequency is low and the replenishment amount is large.

Further, the display control step in the image formation monitoring method according to the present embodiment includes causing the display part 31 to display a predetermined warning based on the replenishment information. According to the above-described configuration, it is possible to encourage improvement when the replenishment content of the user is not preferable.

Furthermore, the display control step in the image formation monitoring method according to the present embodiment includes causing the display part 31 to display the predetermined warning when the replenishment amount of the consumable is equal to or less than a predetermined value in the replenishment information. According to the above-described configuration, it is possible to suppress an increase in the number of times of replenishment and downtime caused by the replenishment amount being equal to or less than the predetermined value.

Further, the image formation monitoring method according to the present embodiment includes a job information acquisition step of acquiring information on a print job performed by the image forming apparatus 10. The image formation monitoring method further includes a determination step of determining, based on the replenishment information and the information on the print job, whether replenishment of the consumable into the container 12 will become necessary between the last replenishment of the consumable into the container 12 and completion of the print job by the image forming apparatus 10. The display control step includes, when it is determined in the determination step that the replenishment of the consumable into the container 12 is unnecessary, causing the display part 31 not to display the predetermined warning even when the replenishment amount into the container 12 is equal to or less than the predetermined value. According to the above-described configuration, even when the replenishment amount is small, the display of the warning is suppressed when the downtime caused by the replenishment does not increase further.

In addition, the image formation monitoring method according to the present embodiment includes the job information acquisition step of acquiring the information on the print job performed by the image forming apparatus 10 and a second calculation step of calculating the replenishment amount into the container 12. The second calculation step includes: calculating the expected number of times of replenishment by dividing the amount of the consumable required for the image forming apparatus 10 to complete the print job by the storage capacity of the container 12 for the consumable; and calculating the predetermined value based on the expected number of times of replenishment. According to the above-described configuration, the user is prompted to replenish the consumable with the number of times of replenishment and the replenishment amount that can most reduce the downtime.

### [Other Configurations]

Although specific description has been given above based on the embodiment according to the present disclosure, the present disclosure is not limited to the above-described embodiment. The present disclosure can be modified in various ways including a scope equivalent to the scope of the invention described in the scope of the claims.

For example, in the above description, a configuration has been exemplified in which the display controller 213 updates the display contents on the display part 31 at times during the image formation processing, but the present invention is not limited thereto. For example, the monitoring apparatus 20 may perform only monitoring and storage in the storage section 22 during the image formation processing, and when the user instructs display of replenishment information in a predetermined container 12 by operating the operation input section 32, the monitoring apparatus 20 may display the graphs illustrated in FIGS. 2 and 3 and warnings. In the above-described configuration, the display controller 213 causes the display part 31 to display a warning, for example, when the replenishment has been performed more than the expected number of times of replenishment calculated by the second calculation section 216 or when the replenishment amount in replenishments other than the last replenishment is equal to or less than the predetermined value.

In the above description, a configuration has been exemplified in which the display controller 213 causes the display part 31 to display a warning, but the present invention is not limited thereto. For example, a configuration may be adopted in which improvement plans corresponding to the contents of the warning are stored in the storage section 22 and the display controller 213 causes the display part 31 to display the improvement plans together with the warning. Specifically, the improvement plans include, for example, increasing replenishment amount per replenishment, reducing the number of times of replenishment, or the like. The display controller 213 compares the expected number of times of replenishment and the predetermined value calculated by the second calculation section 216 with the actual replenishment information to cause the display part 31 to display these improvement plans.

In the above description, the predetermined value of the replenishment amount is calculated by the second calculation section 216, but the present invention is not limited thereto, and the predetermined value may be a predetermined specified value.

Furthermore, although an example in which the HDD is used as a computer-readable medium storing the program according to the present disclosure has been disclosed above, the present invention is not limited to this example. As another computer-readable medium, a portable storage medium such as a CD-ROM can be applied. Furthermore, a carrier wave is also applied as a medium for providing data of the program according to the present disclosure via a communication line.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image formation monitoring method performed by an image formation monitoring apparatus that manages replenishment information on a consumable stored in a container of an image forming apparatus, the image formation monitoring method comprising:
acquiring the replenishment information on a replenishment amount of the consumable replenished into the container; and
causing a display to display the replenishment information in chronological order.

2. The image formation monitoring method according to claim 1, wherein
the acquiring the replenishment information includes:
acquiring a remaining amount of the consumable in the container; and
calculating the replenishment information based on the acquired remaining amount of the consumable, and
the acquiring the remaining amount includes acquiring the remaining amount of the consumable in the container based on a detection result of a sensor provided in the container.

3. The image formation monitoring method according to claim 1, wherein the causing the display includes causing the display to display, as the replenishment information, a ratio of the replenishment amount of the consumable to a storage capacity of the container.

4. The image formation monitoring method according to claim 1, wherein the causing the display includes causing the display to display, as the replenishment information, a graph indicating the replenishment amount into the container in chronological order.

5. The image formation monitoring method according to claim 1, wherein the causing the display includes causing the display to display a predetermined warning based on the replenishment information.

6. The image formation monitoring method according to claim 5, wherein the causing the display includes causing the display to display the predetermined warning when the replenishment amount of the consumable is equal to or less than a predetermined value in the replenishment information.

7. The image formation monitoring method according to claim 6, further comprising:
acquiring information on a print job to be performed by the image forming apparatus; and
determining, based on the replenishment information and the information on the print job, whether replenishment of the consumable into the container will become necessary between last replenishment of the consumable into the container and completion of the print job by the image forming apparatus, wherein,
when the replenishment of the consumable into the container is determined not to be necessary in the determining, the causing the display includes causing the display not to display the predetermined warning even when the replenishment amount into the container is equal to or less than the predetermined value.

8. The image formation monitoring method according to claim 6, further comprising:
acquiring information on a print job to be performed by the image forming apparatus; and
calculating preferable replenishment content based on the information on the print job and information on the container, wherein
the calculating includes:
calculating an expected number of times of replenishment by dividing an amount of the consumable required for the image forming apparatus to complete the print job by a storage capacity of the container for the consumable; and
calculating the predetermined value based on the expected number of times of replenishment.

9. The image formation monitoring method according to claim 4, further comprising acquiring information on a print job to be performed by the image forming apparatus, wherein the causing the display includes causing the display to display an improvement plan for replenishment content based on the replenishment information and the information on the print job.

10. The image formation monitoring method according to claim 9, further comprising calculating preferable replenishment content based on the information on the print job and information on the container, wherein
the calculating includes calculating an expected number of times of replenishment by dividing an amount of the consumable required for the image forming apparatus to complete the print job by a storage capacity of the container for the consumable, and
the causing the display includes causing the display to display the improvement plan based on the expected number of times of replenishment.

11. An image formation monitoring apparatus comprising a hardware processor that performs the image formation monitoring method according to claim 1.

12. An image formation monitoring system comprising:
the image formation monitoring apparatus including the hardware processor that performs the image formation monitoring method according to claim 1; and
the image forming apparatus including:
the container that stores the consumable; and
an image former.

13. A non-transitory computer-readable storage medium storing a program that causes a computer of an image formation monitoring apparatus that monitors image formation by an image forming apparatus to perform the image formation monitoring method according to claim 1.
